(19) United States
(12) Patent Application Publication
(10) Pub. No.: US 2017/0255455 A1
(43) Pub. Date: Sep. 7, 2017

(54) AUTOMATED CUSTOMIZATION OF SOFTWARE FEATURE AVAILABILITY BASED ON USAGE PATTERNS AND HISTORY

(71) Applicant: INTERNATIONAL BUSINESS MACHINES CORPORATION, Armonk, NY (US)

(72) Inventors: Jason A. Collier, Raleigh, NC (US); David L. Leigh, Chapel Hill, NC (US); Yi-Hsiu Wei, Austin, TX (US); Scott A. Will, Louisburg, NC (US); Xianjun Zhu, Durham, NC (US)

(21) Appl. No.: 15/060,085

(22) Filed: Mar. 3, 2016

(51) Int. Cl. G06F 9/445; G06F 11/34; G06Q 30/02; G06F 11/30

(52) U.S. Cl. CPC G06F 8/61; G06F 8/62; G06F 11/302; G06F 11/3495; G06Q 30/0255

(57) ABSTRACT

A computer-implemented method includes: monitoring, by a computing device, usage of an application by a user; detecting, by the computing device, satisfaction of a customization rule based on the monitored usage of the application; and customizing, by the computing device, the application based on the detecting. The customizing may include at least one of: adding a feature to a menu of the application, and adding at least one of a file and link associated with the added feature; and removing a feature from the menu of the application, and removing at least one of a file and a link associated with the removed feature.

### BACKGROUND

The present invention generally relates to customizing software feature availability, and more particularly, to automatically customizing software feature availability based on usage patterns and history.

An application (e.g., a computer software application) may include a group of various features, etc. relating to the functions of the application. The features are often selectable via a toolbar and menu included in the application. Certain users may find that they do not utilize certain features, while other users may find that they may benefit from additional features not currently installed or available in the application. Underutilized or unused features that are currently installed can waste computing resources, such as disk space, processing resources, memory resources, etc. Conversely, productivity and user experience may be suboptimal when certain features exist that a user may wish to use, but when these features are unknown to the user (e.g., if these features are not currently installed).

### SUMMARY

In an aspect of the invention, a computer-implemented method includes: monitoring, by a computing device, usage of an application by a user; detecting, by the computing device, satisfaction of a customization rule based on the monitored usage of the application; and customizing, by the computing device, the application based on the detecting. The customizing may include at least one of: adding a feature to a menu of the application, and adding at least one of a file and link associated with the added feature; and removing a feature from the menu of the application, and removing at least one of a file and a link associated with the removed feature.

In an aspect of the invention, there is a computer program product for customizing available features in an application. The computer program product comprises a computer readable storage medium having program instructions embodied therewith, the program instructions executable by a computing device to cause the computing device to: monitor features historically used in an application; detect that a feature has been used less than a threshold number of times within a particular period of time; and remove the feature from the application based on the detecting that the feature has been used less than the threshold number of times within the particular period of time.

In an aspect of the invention, a system includes: a CPU, a computer readable memory and a computer readable storage medium associated with a computing device; program instructions to store historical usage information for an application; and program instructions to add a related feature to the application that is associated with a feature that is used at a threshold frequency as identified by the historical usage information, where the program instructions are stored on the computer readable storage medium for execution by the CPU via the computer readable memory.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIGS. 4A and 4B show an overview of an example implementation in accordance with aspects of the present invention

FIG. 5 shows an example environment in accordance with aspects of the present invention.

FIG. 6 shows a block diagram of example components of an application customization component in accordance with aspects of the present invention.

FIG. 7 shows an example flowchart for adding or removing features in accordance with aspects of the present invention.

### DETAILED DESCRIPTION

The present invention generally relates to customizing software feature availability, and more particularly, to automatically customizing software feature availability based on usage patterns and history. As used herein, the term “automatically” refers to the performance of an action in connection with aspects of the present invention without user interaction. For example, automatically customizing software features availability refers to the modification of features in which the modification is performed without the explicit instruction of a user to modify or customize the features.

Aspects of the present invention may automatically customize software feature availability by removing features that are underutilized or unused by a particular user. For example, aspects of the present invention may include a system and/or method to monitor a user's patterns and usage habits when using an application, determine that certain features in the application are unused (e.g., based on a set of customization rules), and automatically remove/uninstall the unused features. Advantageously, the presentation of menus within the application is improved, as the menus are automatically modified to include a truncated and customized list of features based on the user's usage patterns of the application. Further, the removal of unused features may save computing resources, such as disk space, memory, loading/processing resources, start-up time, shut-down time, etc.

In alternative embodiments, aspects of the present invention may “reveal” additional features based on features routinely used by the user. For example, aspects of the present invention may automatically install or add features that are associated with features that are commonly used by a user. As an example, if a user commonly uses a debugging feature, aspects of the present invention may add or install additional features that relate to the debugging feature.

In embodiments, aspects of the present invention may be used for cloud-based applications and/or locally installed applications. For cloud-based applications, links to features hosted by a cloud server may be removed in menus of the application, thereby truncating the presentation of the menus. Similarly, links to features residing on a cloud server may be added to menus (e.g., to permit the user to access the added features via the links) based on features that are commonly used by a user.

For locally installed applications (e.g., when the features are available on a local storage medium of a computing device implementing the application), files may be installed in order to add a feature. Similarly, files may be uninstalled or removed in order to delete a feature. In embodiments, files may be downloaded from a remote or cloud server to locally install features.

As described herein, systems and/or methods in accordance with aspects of the present invention may dynamically manage software features by executing a monitoring service to monitor usage of features of a software application; analyzing the monitored usage to identify features of the software application that do not satisfy threshold usage criteria (e.g., have not been used more than a threshold number of times in a threshold period of time); automatically removing menu items for the identified features from the menus of the software application; and automatically uninstalling (i.e., deleting from a storage device) the identified features. Further, the software application may include a microservice architecture (e.g., a single application as a suite of small services, each running in its own process and communicating with lightweight mechanisms, often an HTTP resource API). In embodiments, the identified features may be microservices. In embodiments, the systems and/or methods may identify additional features of the software application to install based on the usage of similar and/or related installed features of the software application; and automatically install the additional features and adding menu items for the additional features to the menus of the software application.

In implementations including a microservice architecture, the added features may include microservices that are added to an application. Similarly, removed features may include microservices that removed from the application. If a microservice to be added is not locally available, it may be accessed from a remote location. For example, files associated with the microservice may be downloaded from the remote location. Additionally, or alternatively, links to the microservice may be added so that the microservice can be accessed via cloud-based techniques.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

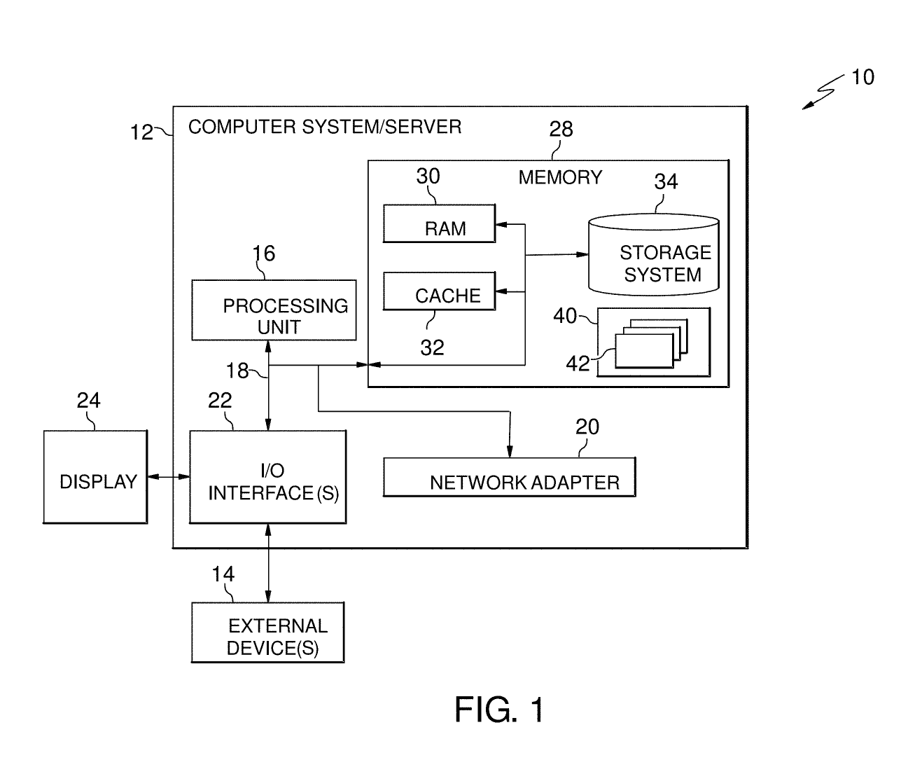

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types.

Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a nonremovable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

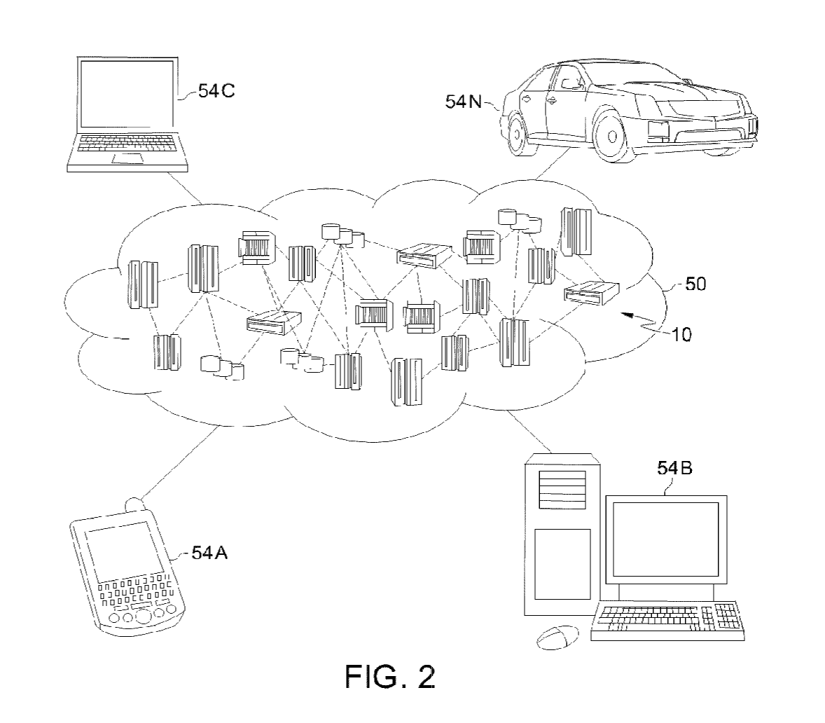

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

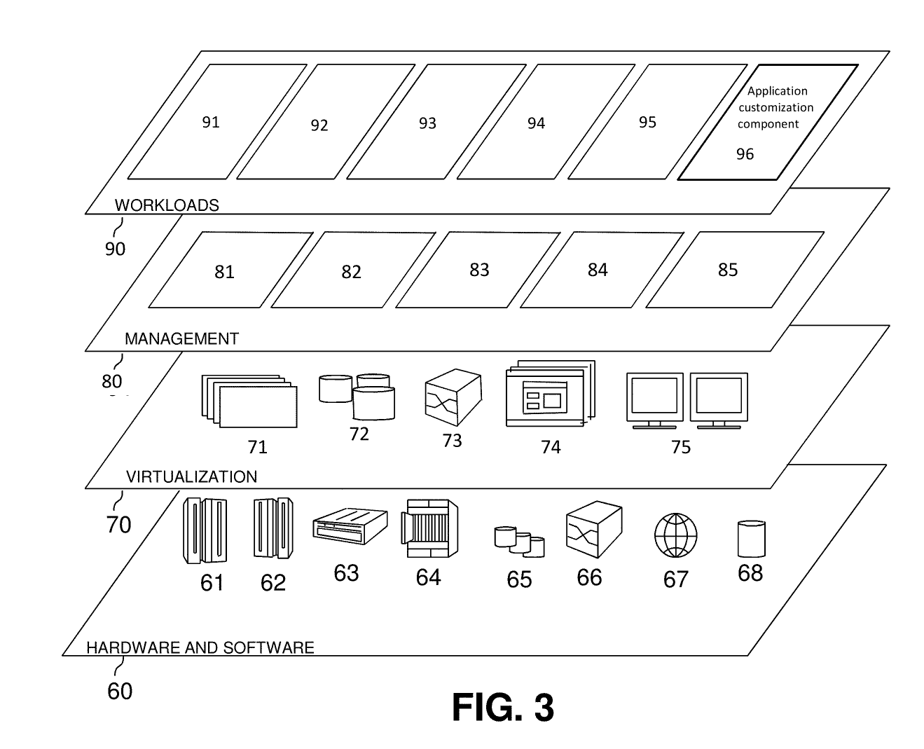

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and application customization component 96.

Referring back to FIG. 1, the Program/utility 40 may include one or more program modules 42 that generally carry out the functions and/or methodologies of embodiments of the invention as described herein. Specifically, the program modules 42 may monitor application usage, identify the satisfaction of customization rules based on application and/or user information, and add or remove features from an application based on the satisfaction of the customization rules. Other functionalities of the program modules 42 are described further herein such that the program modules 42 are not limited to the functions described above. Moreover, it is noted that some of the program modules 42 can be implemented within the infrastructure shown in FIGS. 1-3. For example, the program modules 42 may be representative of an application customization component 96 as shown in FIG. 3.

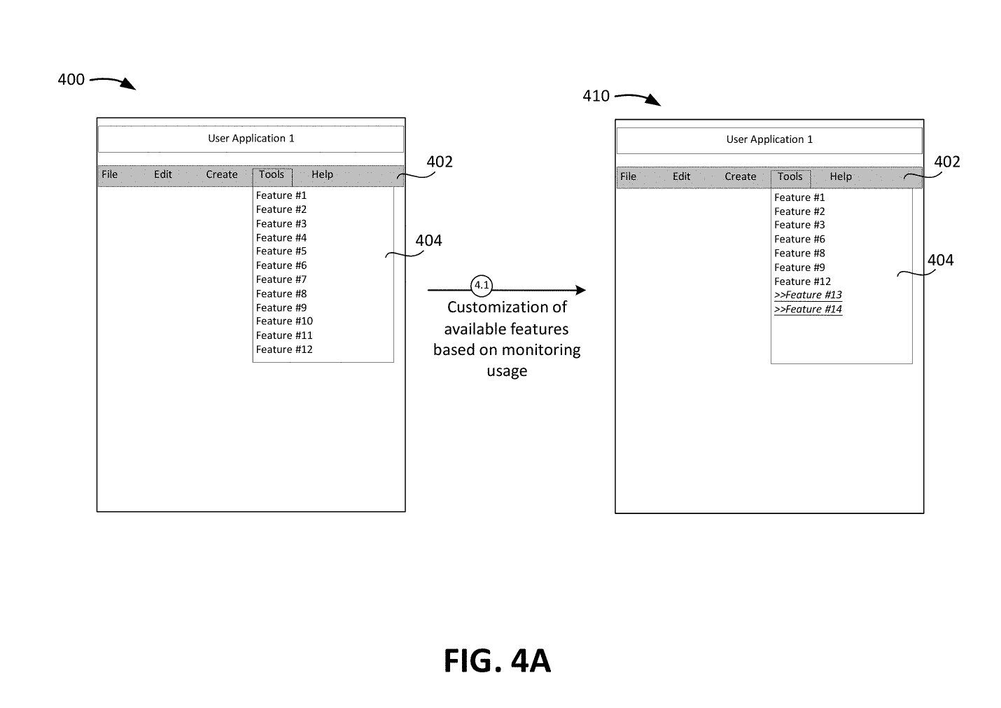

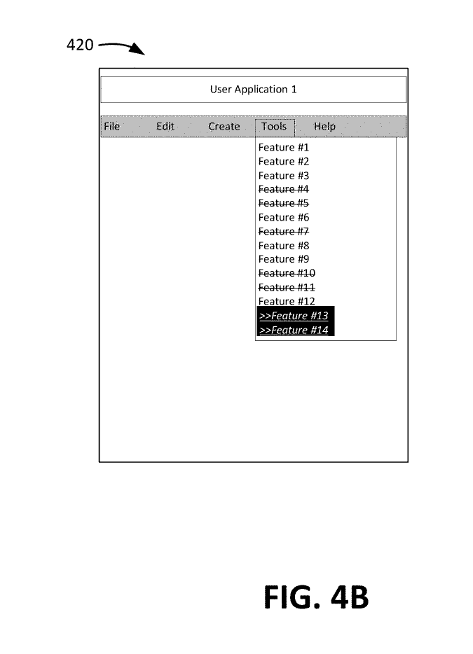

FIGS. 4A-4B show example implementations in accordance with aspects of the present invention. As shown in interface 400 of FIG. 4A, a computing application (e.g., user application 1) may include a list of features accessible via a toolbar 402 and a menu 404 (e.g., a drop-down menu). As a user uses the application over time, aspects of the present invention may customize the available (e.g., installed) features based on the user's usage of the application (at step 4.1). For example, if, after a particular period of time, the user has not used a particular feature, aspects of the present invention may remove the particular feature from the application. Conversely, if the user routinely uses a particular feature, aspects of the present invention may add additional features that are related to the particular feature.

As an illustrative example, assume that features 1-12 are currently installed as shown in interface 400. Over a period of time, certain features may be removed, and other features may be added. As an example shown in interface 410 of FIG. 4A, features 4, 5, 10, and 11 may be removed, and features 13 and 14 may be added. For example, the features may be removed based on user usage information indicated that features 4, 5, 10, and 11 have been unused for a period of time. Features may be added based on information identifying that features 13 and 14 are related to features routinely used by the user. In the example shown in FIG. 4A, the removed features may no longer be displayed in the menu 404, and the added features may be displayed with an indication that the features have been added. For example, the indication of the added features may include larger or different styles of font of the feature, an icon, etc. The indication of the added features may be removed after a certain period of time, or after the user has indicated acknowledgement of the added features (e.g., via selecting an acknowledgement option and/or by selecting to use the added features). As described herein, the menu 404 may include selectable options for features associated with the application. For a local application, the menu 404 may include options to access locally installed features. For a cloud-based application, the menu 404 may include links to access features implemented on a cloud server or application server.

In embodiments, aspects of the present invention may identify features that have been added or removed. For example, referring to interface 420 of FIG. 4B, removed features may be identified via a strikethrough font style. Also, added features may be highlighted. In embodiments, a separate dialog box may be presented that identifies a list of added or removed features. While particular styles for the display of added and removed features is shown in FIGS. 4A and 4B, in practice, the styles of the added and removed features may vary.

In embodiments, aspects of the present invention may provide the user with an opportunity to confirm removal of certain features, or to confirm the addition of other features based on the user's usage history of the application. For example, the user may select to add or remove identified features (e.g., those features that are under consideration for being added or removed). The identified features may initially be presented as suggested features to add or remove. For example, a suggested added feature may be highlighted or otherwise indicated, and a suggested removed feature may be identified via strikethrough font style or other style. In embodiments, if the user takes no action, then a suggested removed feature may be removed within a particular number of days, the next time the application is started, or at some other time. Similarly, a suggested added feature may be within a particular number of days, the next time the application is started, or at some other time.

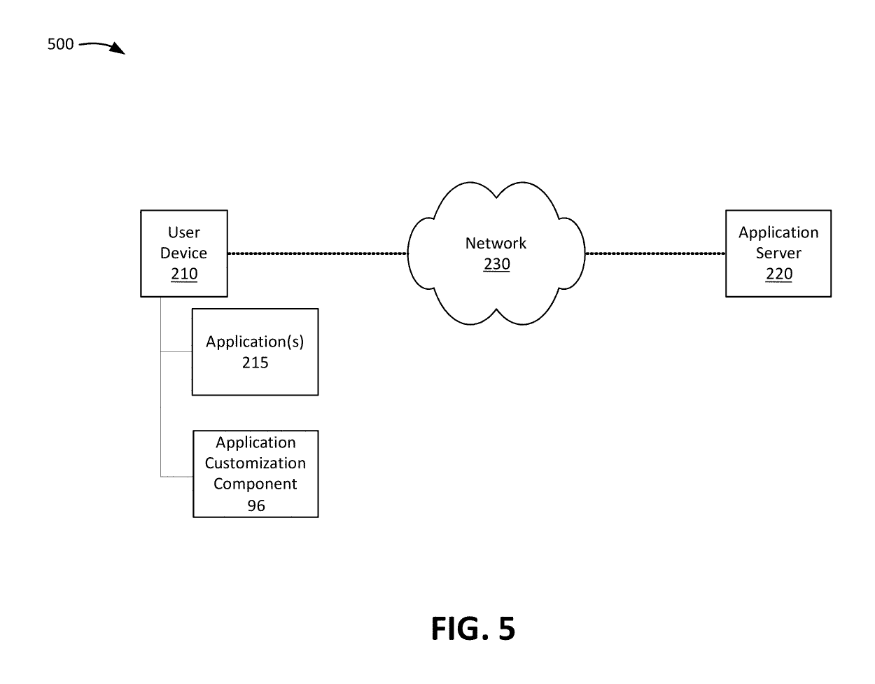

FIG. 5 shows an example environment in accordance with aspects of the present invention. As shown in FIG. 5, environment 500 may include a user device 210, an application server 220, and/or a network 230. In embodiments, one or more components in environment 200 may correspond to one or more components in the cloud computing node of FIG. 1 and/or the cloud computing environment of FIG. 2.

The user device 210 may include a device capable of communicating via a network, such as the network 230. For example, the user device 210 may correspond to a desktop computing device, a server computing device, a portable computing device (e.g., a laptop or tablet), or a mobile computing device (e.g., a smart phone or a personal digital assistant (PDA)), or another type of device. The user device 210 may implement one or more applications 215 that a user of the user device 210 may use to perform any number of desired tasks. The user device 210 may also implement an application customization component 96, as described herein.

In embodiments, an application 215 may be a locally installed application that runs entirely locally on the user device 210. In embodiments, an application 215 may be a cloud-based application that communicates with the application server 220 to function. By way of illustrative, non-limiting examples, the applications 215 may include local and/or cloud-based e-mail/communications applications, calendar applications, gaming applications, financial applications, engineering/design applications, etc.

The application customization component 96 may monitor the usage of an application 215, and may customize the available features of the application 215 based on a set of rules and the usage of the application 215. Additionally, or alternatively, the application customization component 96 may customize the available features of the application 215 based on user information, as described in further detail herein. In embodiments, the application customization component 96 may automatically remove or uninstall features of the application 215 (or add features of the application 215) based on the usage of the application 215. For a locally installed application 215, the application customization component 96 may add or remove software packages, scripts, and/or other computer files associated with added or removed features. For a cloud-based application 215, the application customization component 96 may add or remove links to added or removed features implemented on the application server 220.

The application server 220 may include one or more computing devices that hosts applications accessible via the user device 210. For example, the application server 220 may host loud-based e-mail/communications applications, calendar applications, gaming applications, financial applications, engineering/design applications, etc.

The network 230 may include network nodes, such as network nodes 10 of FIG. 2. Additionally, or alternatively, the network 230 may include one or more wired and/or wireless networks. For example, the network 230 may include a cellular network (e.g., a second generation (2G) network, a third generation (3G) network, a fourth generation (4G) network, a fifth generation (5G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, the network 230 may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks.

The quantity of devices and/or networks in the environment 500 is not limited to what is shown in FIG. 5. In practice, the environment 500 may include additional devices and/or networks; fewer devices and/or networks; different devices and/or networks; or differently arranged devices and/or networks than illustrated in FIG. 5. Also, in some implementations, one or more of the devices of the environment 500 may perform one or more functions described as being performed by another one or more of the devices of the environment 500. Devices of the environment 500 may interconnect via wired connections, wireless connections, or a combination of wired and wireless connections.

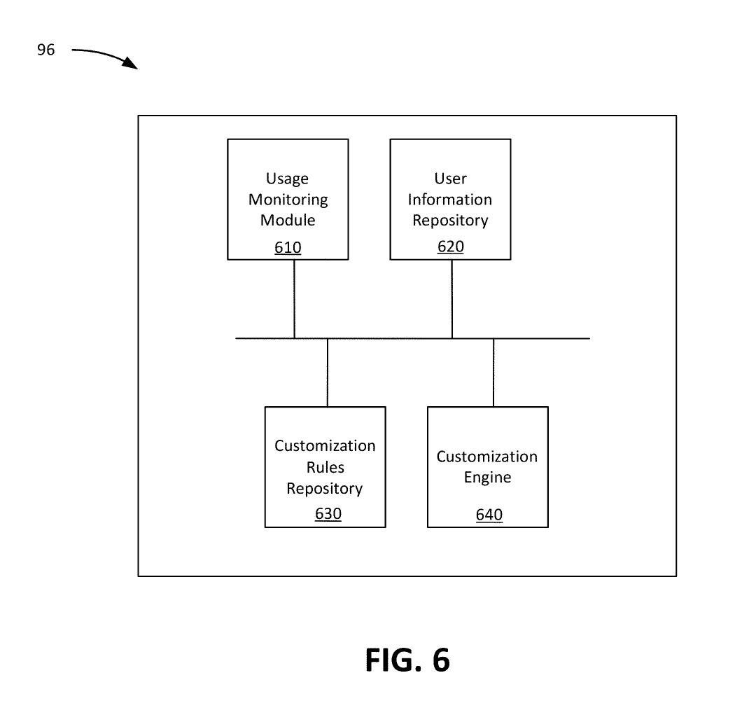

FIG. 6 shows a block diagram of example components of an application customization component 96 in accordance with aspects of the present invention. As shown in FIG. 6, the application customization component 96 may include a usage monitoring module 610, a user information repository 620, a customization rules repository 630, and a customization engine 640. In embodiments, the application customization component 96 may include additional or fewer components than those shown in FIG. 6. In embodiments, separate components may be integrated into a single computing component or module. Additionally, or alternatively, a single component may be implemented as multiple computing components or modules.

The usage monitoring module 610 may include a program module (e.g., program module 42 of FIG. 1) that monitors the usage of an application by a user (e.g., an application 215 as described in FIG. 5). For example, the usage monitoring module 610 may monitor usage information with the application, such as features used by the user, the frequency in which features are used, user interactions with the application, etc. In embodiments, the usage monitoring module 610 may store the usage information in an activity log. In embodiments, the usage monitoring module 610 may monitor activity logs that are already generated by the application (e.g., for applications that have been designed to generate and store activity logs). The usage monitoring module 610 may store historical usage information for the application based on monitoring the usage of the application by the user.

The user information repository 620 may include a data storage device (e.g., storage system 34 of FIG. 1) that stores information regarding the user. For example, the user information repository 620 may store information regarding the user's interests, job title, job roles, etc. The user information may be used to better customize the available applications. For example, users having particular job roles may be more likely to use certain features.

The customization rules repository 630 may include a data storage device (e.g., storage system 34 of FIG. 1) that stores information identifying features to add or remove from an application based on usage history of the application and/or user information. For example, the customization rules repository 630 may store a rule to remove a particular feature from the application when the feature has not been used in a particular period of time (e.g., 30 days). As another example, the customization rules repository 630 may store a rule to remove a feature when the feature has not been used for a threshold frequency. For example, the rule may state that a feature should be removed when the feature has been used less than a threshold number of times in a particular period of time (e.g., used 3 times in 90 days). The customization rules repository 630 may also store rules to remove a feature based on the user's information. As an example, the customization rules repository 630 may store a rule to remove a feature that is unrelated to the user's job roles or functions. Customization rules repository 630 may store a rule to add a related feature when a particular feature has been used greater than a threshold number of times. For example, the customization rules repository 630 may store a rule to add an extension of a debugging feature (or other related feature) if the debugging feature has been used greater than a threshold number of times in a particular period of time. As another example, the customization rules repository 630 may store a rule to add a particular feature based on the user's information (e.g., a rule to add a feature that is related to the user's job roles or functions). In embodiments, the customization rules may be configured or customizable by the user and/or by an operator or developer of the application.

The customization engine 640 may include a program module (e.g., program module 42 of FIG. 1) that identifies that a customization rule has been satisfied, and customizes the application in accordance with the customization rule. For example, the customization engine 640 may identify that a customization rule has been satisfied based on the usage history as monitored by the usage monitoring module 610 and/or the user's information stored by the user information repository 620. As an example, the customization engine 640 may identify the satisfaction of a customization rule to remove a feature when the feature has not been used for a period of time (e.g., when the usage history, as determined by the usage monitoring module 610, indicates that the feature has not been used for the period of time specified in the customization rule). The customization engine 640 may customize the application by removing or adding features as indicated by the customization rule. For locally installed applications, the customization engine 640 may add or remove software packages, scripts, and/or other computer files associated with added or removed features. For cloud-based applications, the customization engine 640 may add or remove links to added or removed features implemented on an application server (e.g., the application server 220 of FIG. 5). In embodiments, the customization engine 640 may add an application by accessing installation scripts and/or other necessary files (e.g., from an application server and/or from an external or cloud-based device).

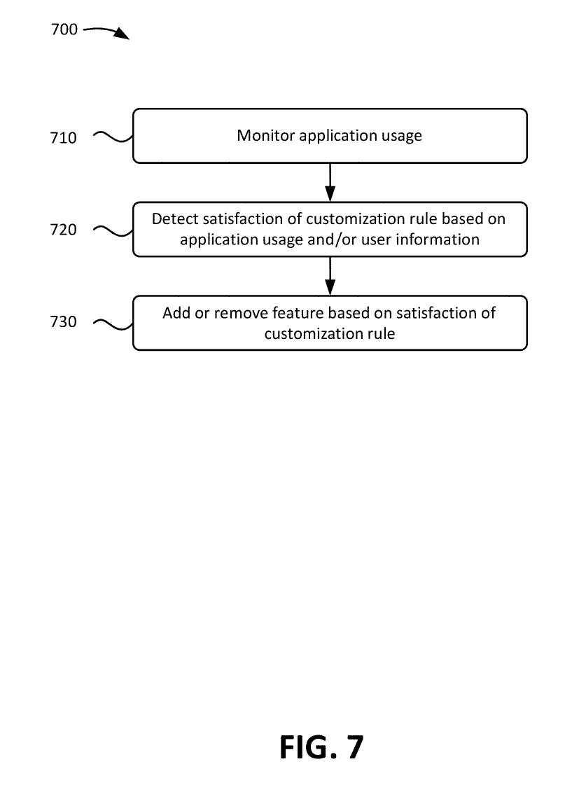

FIG. 7 shows an example flowchart for adding or removing features in accordance with aspects of the present invention. The steps of FIG. 7 may be implemented in the environment of FIG. 5, for example, and are described using reference numbers of elements depicted in FIG. 5. As noted above, the flowchart illustrates the architecture, functionality, and operation of possible implementations of systems, methods, and computer program products according to various embodiments of the present invention.

As shown in FIG. 7, process 700 may include monitoring application usage (step 710). For example, as described with respect to the usage monitoring module 610 of FIG. 6, the application customization component 96 may monitor usage information with the application, such as features used by the user, the frequency in which features are used, user interactions with the application, etc. In embodiments, the usage monitoring module 610 may store the usage information in an activity log. In embodiments, the application customization component 96 may monitor activity logs that are already generated by the application (e.g., for applications that have been designed to generate and store activity logs).

Process 700 may further include detecting the satisfaction of a customization rule based on the application usage and/or user information (step 720). For example, as described above with respect to the customization engine 640 of FIG. 6, the application customization component 96 may detect that a customization rule has been satisfied based on the usage history as monitored by the usage monitoring module 610 and/or the user's information stored by the user information repository 620. As an example, the application customization component 96 may detect the satisfaction of a customization rule to remove a feature when the feature has not been used for a period of time (e.g., when the usage history, as determined by the usage monitoring module 610, indicates that the feature has not been used for the period of time specified in the customization rule).

Process 700 may also include adding or removing a feature based on the satisfaction of the customization rule (step 730). For example, as described above with respect to the customization engine 640 of FIG. 6, the application customization component 96 may automatically add or remove features as indicated by the customization rule that was previously satisfied in step 720. In embodiments, the application customization component 96 may automatically add or remove features as shown in the examples of FIGS. 4A and 4B. For cloud-based applications, the application customization component 96 may add or remove links to added or removed features implemented on an application server (e.g., the application server 220 of FIG. 5). In embodiments, the application customization component 96 may add an application by accessing installation scripts and/or other necessary files (e.g., from an application server and/or from an external or cloud-based device).

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer system/server 12 (FIG. 1), can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
monitoring, by a computing device, usage of an application by a user;
detecting, by the computing device, satisfaction of a customization rule based on the monitored usage of the application; and
customizing, by the computing device, the application based on the detecting, wherein the customizing includes at least one of:
adding a feature to a menu of the application, and adding at least one of a file and link associated with the added feature; and
removing a feature from the menu of the application, and removing at least one of a file and a link associated with the removed feature.

2. The method of claim 1, wherein the adding the at least one file includes installing the at least one file to a storage device of the computing device, and
wherein removing the at least one of the file includes removing or uninstalling the at least one of the file from the storage device of the computing device.

3. The method of claim 1, wherein the link associated with the added feature provides access to a cloud server that hosts the added features.

4. The method of claim 2, further comprising visually presenting an indication identifying the added or removed features within the application.

5. The method of claim 4, wherein the visual presentation of the added features includes at least one of:
a modified font style of text corresponding to the added features;
a highlighting of text corresponding to the added features; and
additional characters appended to the text of the added features.

6. The method of claim 4, wherein the visual presentation of the removed features includes at least one of:
a modified font style of text corresponding to the removed features;
a strikethrough style of text corresponding to the removed features; and
additional characters appended to the text of the removed features.

7. The method of claim 1, further comprising: presenting a suggested feature to add or removed based on the detection of the satisfaction of the customization rule.

8. The method of claim 7, further comprising receiving a selection to remove a suggested feature, wherein customizing the application is based on receiving the selection to remove the suggested feature.

9. The method of claim 7 further comprising receiving a selection to add a suggested feature, wherein customizing the application is based on receiving the selection to add the suggested feature.

10. The method of claim 1, wherein a service provider at least one of creates, maintains, deploys and supports the computing device.

11. The method of claim 1, wherein steps of claim 1 are provided by a service provider on a subscription, advertising, and/or fee basis.

12. The method of claim 1, wherein the computing device includes software provided as a service in a cloud environment.

13. The method of claim 1, further comprising deploying a system for customizing available features in an application, comprising providing a computer infrastructure operable to perform the steps of claim 1.

14. A computer program product for customizing available features in an application, the computer program product comprising a computer readable storage medium having program instructions embodied therewith, the program instructions executable by a computing device to cause the computing device to:
monitor features historically used in an application;
detect that a feature has been used less than a threshold number of times within a particular period of time; and
automatically remove the feature from a drop-down menu in the application based on the detecting that the feature has been used less than the threshold number of times within the particular period of time.

15. The computer program product of claim 14, wherein automatically removing the feature is based on user information of a user of the application.

16. The computer program product of claim 14, wherein the program instructions further cause the computer device to:
detect that the feature has been used greater than the threshold number of times within a particular period of time; and
automatically add a related feature to the drop-down menu in the application based on the detecting that the feature has been used greater than the threshold number of times within the particular period of time.

17. The computer program product of claim 14, wherein the automatically removing the features includes removing files or links associated with the removed features,
wherein removing the files includes removing the files from the computer readable storage medium,
wherein the links provide access to a cloud server that hosts the removed features.

18. A system comprising:
a CPU, a computer readable memory and a computer readable storage medium associated with a computing device;
program instructions to store historical usage information for an application; and
program instructions to automatically add a related feature to the application that is associated with a feature that is used at a threshold frequency as identified by the historical usage information,
wherein the program instructions are stored on the computer readable storage medium for execution by the CPU via the computer readable memory.

19. The system of claim 18, wherein the program instructions to add the related feature includes adding files or links associated with the related feature. wherein adding the files includes installing the files to the computer readable storage medium,
wherein the links provide access to a cloud server that hosts the added features.

20. The system of claim 18, further comprising program instructions to remove a feature from the application when the feature is used less than a threshold frequency.
